(19) United States
(12) Patent Application Publication
(10) Pub. No.: US 2005/0103136 A1
(43) Pub. Date: May 19, 2005

(54) Starting device

(76) Inventors: Hans Braun, Stuttgart (DE); Juergen Kugler, Loechgau (DE)

Correspondence Address: Striker, Striker & Stenby, 103 East Neck Road, Huntington, NY, 11743, US

(21) Appl. No.: 10/130,806

(22) PCT Filed: Sep. 21, 2001
(86) PCT No.: PCT/DE01/03629

(30) Foreign Application Priority Data
Sep. 21, 2000 (DE) 100 47 477.2

(51) Int. Cl. F02N 15/00

(52) U.S. Cl. 74/7 E; 475/296

(57) ABSTRACT

A starter device for internal combustion engines is proposed that comprises a drive mechanism (16) and a gearing (22) having a variable gear ratio, which said gearing is situated after the drive mechanism (16). The starter device (10) is characterized by the fact that the gear ratio of the gearing (22) is infinitely variable.

### BACKGROUND OF THE INVENTION

The invention concerns a starter device for internal combustion engines according to the general class in the independent claim. A starter device is made known in DE 199 27 905 A1, which said starter device comprises a gearing between a drive element and a pinion, which said gearing has a variable gear ratio. The gearing is a planetary-gear set, the sun gear of which is capable of being driven by the drive element. The output of the planetary-gear set takes place via the planet gears and, therefore, via the planetary carrier. The planetary-gear set makes two different gear ratios possible: in the case of the first gear ratio at low speeds, gear reduction takes place via the internal ring gear, which is held stationary by means of an overrunning clutch. When the drive mechanism reaches a certain speed, a plurality of centrifugal clutch elements attached to the planetary carrier cause the internal ring gear to be held stationary with the planetary carrier; this causes the planetary-gear set to be shifted from gear reduction to a one-to-one gear ratio. The disadvantage of this embodiment is the fact that the assistance provided to run the internal combustion engine up to speed is adjusted optimally at only two operating points.

### ADVANTAGES OF THE INVENTION

The starter device according to the invention having the feature of the main claim has the advantage that the starter device can be adjusted as favorably as possible for the operating states of the internal combustion engine during start-up by means of the variable gear ratio of the gearing. As a result, the assistance provided by the starter device to run the internal combustion engine up to speed is optimal.

The continuously-variable design of the gearing leads to reduced wear and reduced noise in the gearing, because no force or load peaks occur here when the gear ratio is changed. Advantageous further developments of the starter device according to the main claim are possible due to the measures listed in the dependent claims. The expense required to realize the variable gear ratio in the case of the starter device is particularly low when the gearing is self-regulating. Sensors, adjusting devices, and expensive control technology can be eliminated.

### SUMMARY OF THE DRAWINGS

Exemplary embodiments of a starter device according to the invention are shown in the drawings.

FIG. 1 shows a schematic view of a starter device according to the invention.

FIG. 2 shows a spacial sectional detail view of the torque-controlled gearing,

FIG. 3 shows a spacial sectional detail view of the speed-controlled gearing,

FIG. 4 shows a spacial view of the coupled planet gears.

### DESCRIPTION OF THE PREFERRED EMBODIMENTS

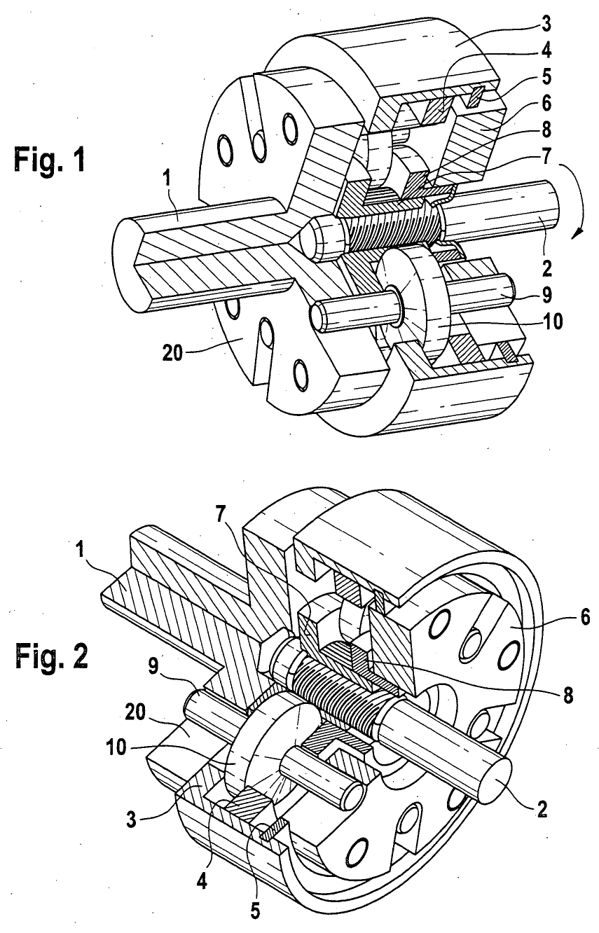

A starter device 10 is shown FIG. 1, which said starter device accommodates a plurality of assemblies in a housing 13. The assemblies include the drive mechanism 16 that drives an output shaft 25 via an input shaft 19, and a gearing 22. A pinion-engaging drive mechanism 28 is supported on the output shaft 25 in rotating-slideable fashion. The pinion-engaging drive mechanism 28 is capable of being engaged with a not shown ring gear of an internal combustion engine by means of a solenoid switch 31.

A first exemplary embodiment of the gearing 22 is shown in FIG. 2. This first exemplary embodiment is a gearing having a variable gear ratio, and the gear ratio is continuously-variable. The gearing 22 is designed as a planetary-gear set. A center gear 34 having a double-component design is driven via the input shaft 19. The center gear 34 is composed of a first side gear 37 and a second side gear 40. The first side gear 37 and the second side gear 40 each comprise side surfaces 43 that face each other, between which said side surfaces at least one planet gear 46 can be held tightly. A further gear element is the internal gear 49, which also has a double-component design. The internal gear 49 is composed of a first side internal gear 52 and a second side internal gear 55. Both the first and second side internal gears 52 and 55 have side surfaces 53 that face each other. One flange element is situated on each side of the planet gears 46, and an output flange 58 is integrally connected to the output shaft 25 on the output end. An annular input flange 61 is arranged on the input end. The output flange 58 and the input flange 61 are interconnected in torsion-resistant fashion. This torsion-resistant connection is obtained by arranging opposing bores 64 in the output flange 58 and the input flange 61. Bolts 67 are inserted through said bores for connecting purposes. The output flange 58 and the input flange 61 are interconnected in torsion-resistant and axially non-displaceable fashion.

The input flange 61 as well as the output flange 58 comprise radially outwardly extending grooves 70 on their circumferences. These grooves 70 allow the axles 73—on which the planet gears 46 are securely arranged—to slide radially outwardly or radially inwardly in them.

The input shaft 19 comprises a shaft section 76 in which a helical spline 77 is machined. The helical spline 77 is limited on both ends by two circlips. The first circlip acts as a stop for the first side gear, and the other circlip acts as a stop for the second side gear. The first side gear 37 comprises a center bore in which a helical spline 77 is machined as well. The first side gear 37 further comprises a cylindrical outer section 80 in which straight teeth are machined. The outer section 80 lies radially within the planet gears 46. The second side gear 40 is placed on the outer section 80 having the straight teeth 81, which said side gear comprises an internal straight toothing that matches the straight teeth 81 and meshes with them. In a first variant, the second side gear 40 comprises an axially extending, cylindrical section 84 facing the drive mechanism, which said section can be displaceably supported with its exterior in a bore 86 of the input flange 61. In a second variant, the cylindrical section 84 can extend only into the input flange 61—due to spacial considerations—without transferring bearing forces here. The motion of the second side gear is hindered by means of the other circlip via a plate washer arranged at the end of the cylindrical section 84.

The internal gear 49 encompasses—with the first side internal gear 52 and the second side internal gear 55—the at least one planet gear 46. The second side internal gear 55 is thereby supported in moveable fashion within the first side internal gear 52. The second side internal gear thereby bears against an internal retainer 95 by means of a spring element 93. The first side internal gear 52 is supported in displaceable fashion within the housing 13. The at least one planet gear 46 has a biconical design overall, and the planet gear 46 comprises an outwardly directed conical surface 47 on each of its rotational-axial ends.

The function of the starter device 10—particularly the gearing 22—will be explained hereinbelow. The starting position of the gearing 22 is as follows: The drive mechanism 16 does not yet apply input torque, so the planet gears 46 assume their radially innermost positions. This is due to the spring element 93, which presses on the second side internal gear 55, by way of which the first side internal gear 52 comes to bear against the planet gears 46. Due to the conical surfaces 47 and the forces acting on the conical surfaces 47 by the side internal gears 52 and 55, this leads to a radially inwardly directed force on the planet gears 46; the planet gears 46 assume their radially innermost positions.

After the starter device 10 is started, the input shaft 19 begins to rotate anticlockwise. Due to the helical spline 77, the first side gear 37 is drawn in the direction toward the drive mechanism 16. The first side gear 37 thereby presses with its side surface 43 against the conical surface 47 of the planet gear 46 and moves it in the direction toward the side gear 40 until said side gear comes to bear against one of the side surfaces 43 there. Since the sliding motion on the helical spline 77 has now stopped, input torque from the drive mechanism 16 is transferred to the center gear 34, which said center gear now drives the planet gears 46. The planet gears 46 thereby roll with their conical surfaces 47 on the side surfaces 43 of the first and second side internal gears 52 and 55 as well. The side surfaces do not rotate therewith; instead, they are axially displaceable. The planet gears 46 thereby drive the output flange 58 and the input flange 61 via the axles 73 and the grooves 70, so that output torque is transferred to the pinion-engaging drive mechanism 28 via the output shaft 25.

Due to the very high initial input torque in the case of drive mechanisms 16 designed as electric motors, this leads to high clamping forces between the first and second side gears 37 and 40. These clamping forces ultimately lead to the forces exceeding the spring forces of the spring element 93, so that the first and second side internal gears 52 and 55 are forced apart. The planet gears 46 walk radially outwardly. This leads to a situation in which, based on the axles 73 and [numeral missing?], the planet gears 46 cover an ever-increasing rolling circle, which finally reaches a maximum. The reverse applies for the pitch lines between the first and second side internal gears 52 and 55 and the planet gear 46. Here, the radius, i.e., the distance between the center line of the axles 73 and the pitch lines, becomes smaller and smaller. The significance of this for the speed ratios that occur between the input shaft 19 and the output shaft 25 is that, when the planet gears 46 initially lie radially inwardly, the output shaft 25 rotates rapidly compared to the input shaft 19. When the planet gears 46 move further outwardly, the kinematic relationships then change in such a fashion that the speed of the output shaft 25 decreases compared to the initial situation.

Assuming a constant drive power of the drive mechanism 16, the significance of this for torque output by the output shaft 25 is that the torque at the output shaft 25 increases as the planet gears 46 wander further outwardly. This is favorable in terms of starting internal combustion engines, because said internal combustion engines require a particularly high amount of torque at the beginning of the starting procedure.

Once the internal combustion engine has broken away, the torque demand of the internal combustion engine drops continuously. As a result, the drive mechanism 16 need not deliver as much input torque via the input shaft 19 to the gearing 22, either. Consequently, this leads to a reduced force in the helical spline 77 and, therefore, to lesser forces between side faces 43 of the first side gear and the second side gear 37 and 40. The force of the spring element 93 now becomes greater than the force acting on the spring element 93 from the helical spline 77, so that the side faces 43 of the first side internal gear 52 and the second side internal gear 55 press on the conical surfaces 47 of the planet gears 46 with greater force than the force between the side surfaces 43 of the first and second side gears 37 and 40. As a result, the planet gears 46 move radially inwardly along the grooves 70 once more, so that, on the one hand, the torque at the output shaft 25 decreases and, on the other hand, the speed of the output shaft 25 increases.

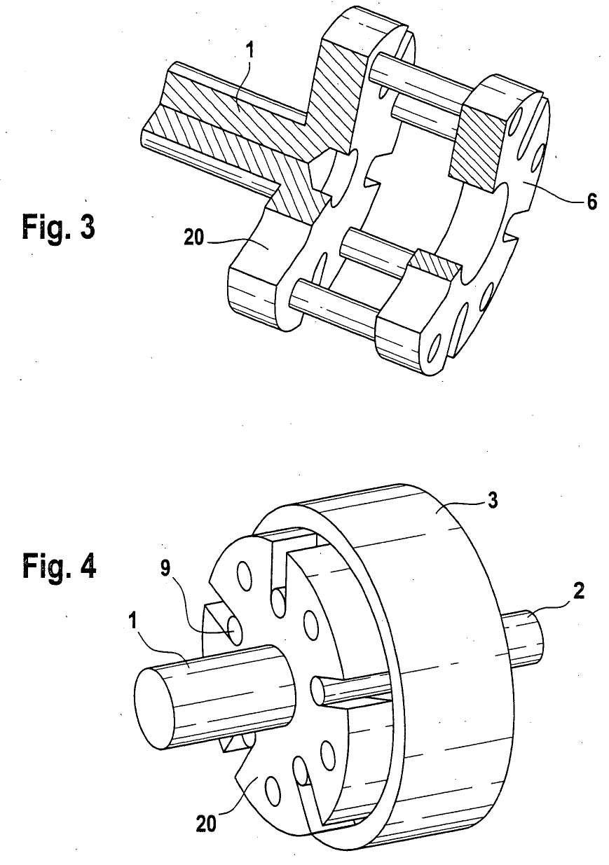

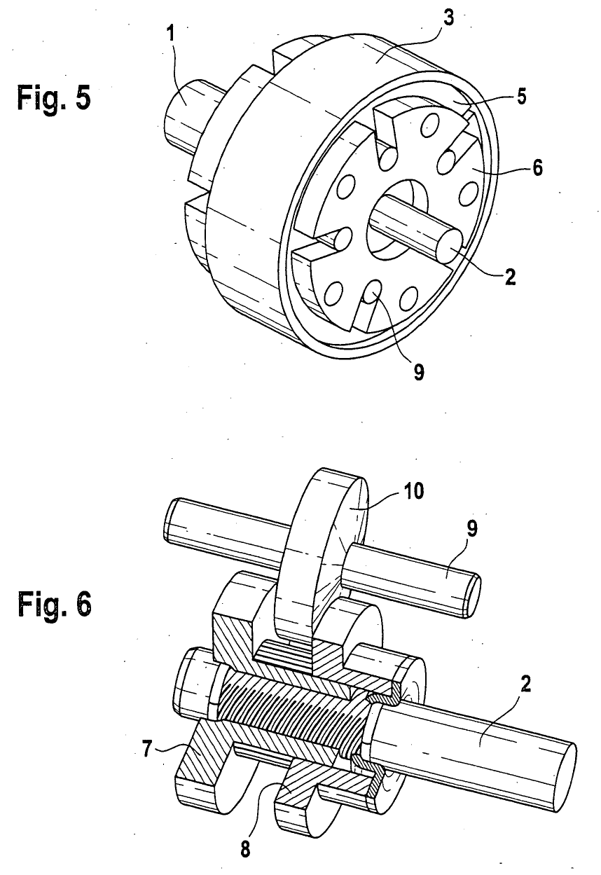

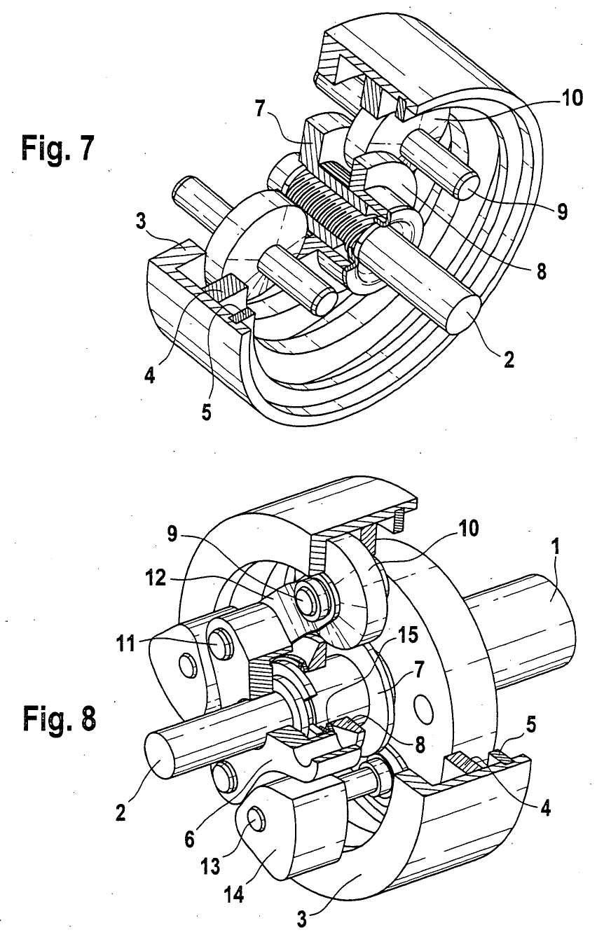

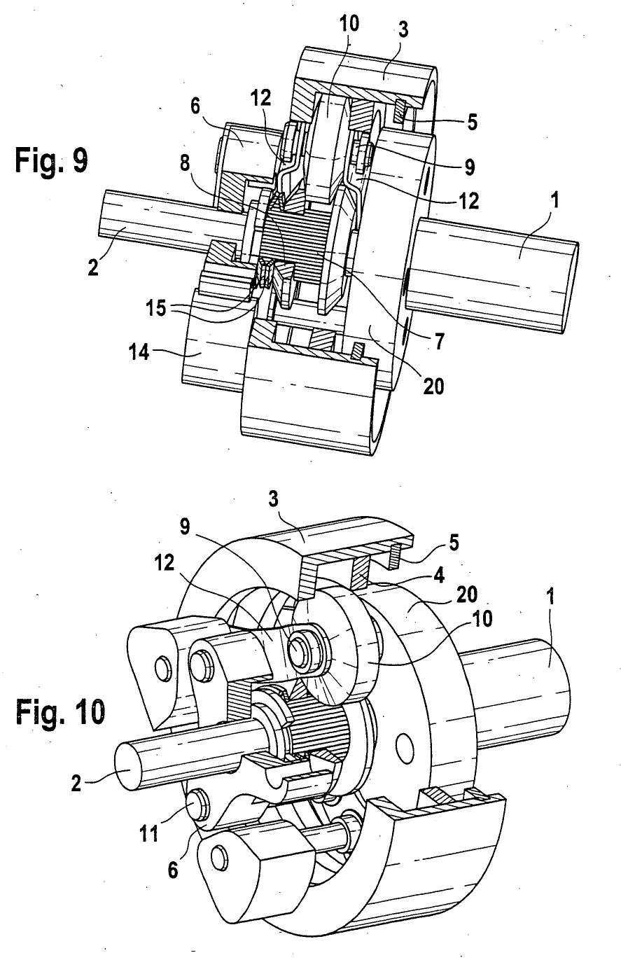

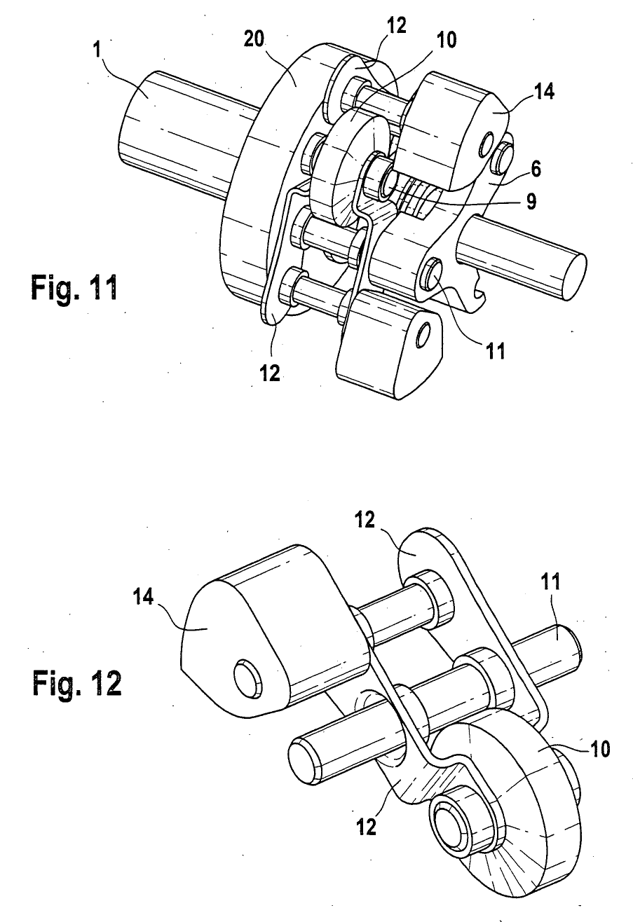

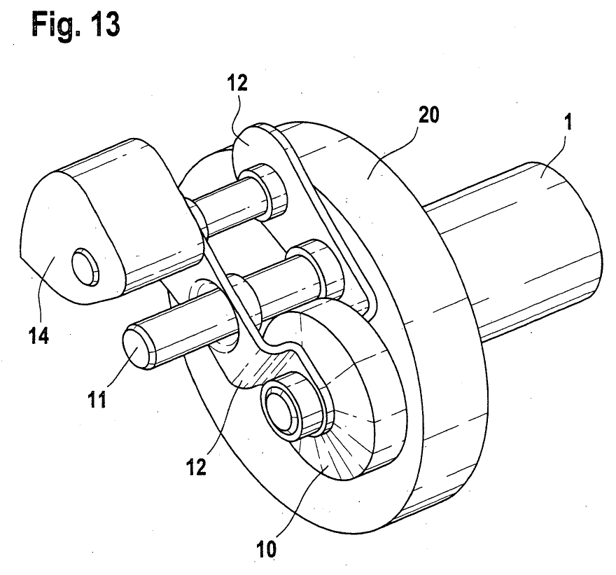

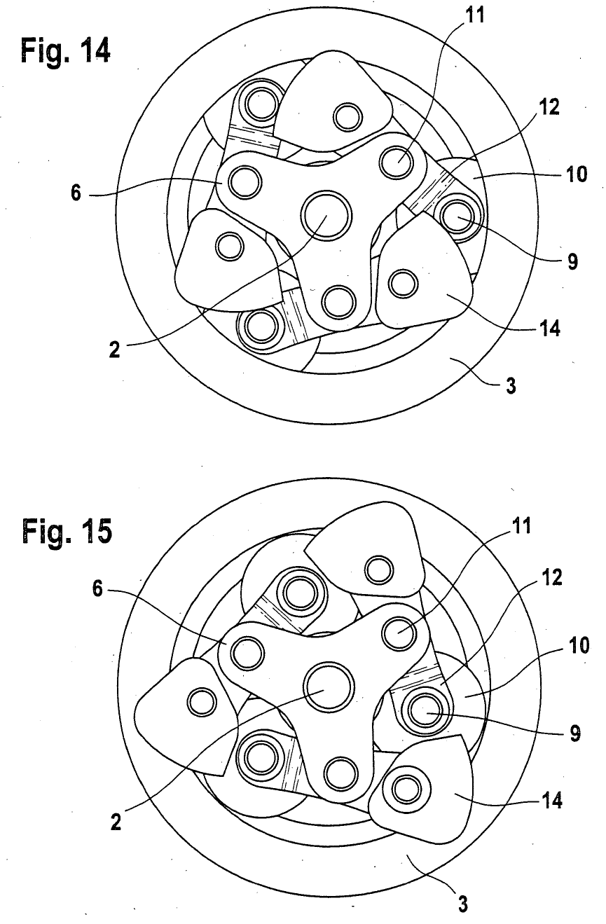

The second exemplary embodiment of the gearing 22 is shown in FIG. 3. In contrast to the gearing 22 shown in FIG. 2, this exemplary embodiment is regulated according to the drive speed of the drive mechanism 16. The input shaft 19 has a positive contour via the shaft section on which the center gear 34 is arranged, which said contour meshes with a matching positive counter-contour of the center gear 34. These two positive contours make an axial displacement of the center gear 34 on the input shaft 19 possible. The center gear 34 also comprises a first side gear 37 with the side surface 43. The side surface 43 of the first side gear 37 cooperates with a second side surface 43 that is part of a surface of a center ring 98. The center ring 98 is held on the center gear 35 by the fact that said center gear 34 bears against a retainer 104 secured to the first side gear 37 via a spring element 101. The side surfaces 43 of the center ring 98 and the first side gear 37 encompass a plurality of planet gears 46 which are encompassed by the side surfaces 43 of an internal gear 49 on their radial exterior, as is the case with the first exemplary embodiment. The internal gear 49 is designed analogously to the first exemplary embodiment. A plurality of bores 64 is machined in the output flange 58, in which bores a plurality of bolts 67 is secured. The bolts 67 carry a planetary gear carrier 107 which is arranged on the side of the center gear 34 facing the drive mechanism 16. The planetary gear carrier 107 carries a multiple-component swivel arm 109 on the bolts 67, refer to FIG. 4 as well. The swivel arm 109 is arranged between the output flange 58 and the planetary gear carrier 107. The swivel arm comprises two individual arms 111, each of which comprises three individual openings along their length. The openings are aligned with each other in each case. The center openings serve to support the planetary gear carrier 107 on the bolt 67. Two lower openings accommodate an axle 113, to which a counterweight 114 is secured. Two upper openings accommodate the axle 73, on which the planet gear 46 is situated. The planet gear 46 is held between the two individual arms 111.

The function of the second exemplary embodiment will be explained using FIGS. 3 and 4. If the input shaft 19 of the drive mechanism 16 is driven, the center gear 34 is rotated simultaneously. The planet gears 46 are driven via the side surfaces 43 of the first side gear and the center gear 98 via frictional forces. The planet gears 46 thereby roll on the side surfaces 43 of the internal gear 49 in an already-known fashion. If the speed of the output shaft 25 is relatively low at first, the side surfaces of the center gear 34 initially force the planet gears 46 radially outwardly with assistance from the spring element 101. As a result, the spring element 93 of the internal gear 49 is loaded. The output torque at the output shaft 25 is therefore relatively high initially and serves to break away or start the internal combustion engine. If the speed of the output shaft 25 then increases, this means an increase in the angular speed of the planetary gear carrier 107 and, therefore, an increase in the angular speed of the counterweights 114 as well. Due to the kinematic relationships at the swivel arm 109, the increasing centrifugal force of the counterweights 114 leads to an increased axial force in the center gear 34, so that the side surfaces 43 of the center gear 34 are forced apart. The kinematic relationships in the gearing 22 therefore change as well, so that planet gear 46 therefore moves radially inwardly once more, and the speed of the output shaft 25 increases over-proportionally to the speed of the input shaft 19.

1. A starter device for internal combustion engines comprising a drive mechanism (16) and a gearing (22) having a variable gear ratio, which said gearing is situated after the drive (16),
wherein the gear ratio is infinitely variable.

2. The starter device according to claim 1,
wherein the gearing (22) is self-regulating.

3. The starter device according to claim 1,
wherein the gearing (22) is capable of being regulated according to a input torque of the drive mechanism (16).

4. The starter device according to claim 1,
wherein the gearing (22) is capable of being regulated according to a drive speed of the drive mechanism (16).

5. The starter device according to claim 1,
wherein the gearing (22) is a planetary-gear set with a center gear (34) having at least one planet gear (46) and a internal gear (49), and
wherein a radial actuating force acting on the at least one planet gear (46) can be achieved by means of the input torque.

6. The starter device according to claim 1,
wherein the gearing (22) is a planetary-gear set with a center gear (34) having at least one planet gear (46) and a internal gear (49), and
wherein a radial actuating force acting on the at least one planet gear (46) can be achieved by means of the drive speed.
